(19) United States
(12) Patent Application Publication
(10) Pub. No.: US 2010/0186714 A1
(43) Pub. Date: Jul. 29, 2010

(54) Fuel saving spring assembly, kit, and method

(76) Inventor: Nicholas P. Bucci, Woodstock, IL (US)

Correspondence Address: Meroni & Meroni, P. C., P. O. Box 309, Barrington, IL, 60011, US

(21) Appl. No.: 12/321,931

(22) Filed: Jan. 27, 2009

(51) Int. Cl. F02D 11/02

(52) U.S. Cl. 123/396

(57) ABSTRACT

A spring assembly is attached to an accelerator pedal for enhancing fuel economy of a motor vehicle. The combination of operable elements thus comprises an accelerator pedal, a conical compression spring, and fastening hardware to attach the compression spring to the pedal. An optional spring seat is included for certain installations. The pedal has an aperture extending between its upper and lower pedal surfaces. The spring has an upper spring end and a lower spring end. The fastening hardware attaches said spring to said pedal, and comprises a bolt, a flat washer, a lock washer, and a nut. The spring is compressible intermediate the lower pedal surface and a fixed surface underlying the pedal such as the floor of an automobile. The spring thereby provides non-linear resistance as a function of compressive spring displacement via the pedal for improving fuel economy of a motor vehicle.

### BACKGROUND OF THE INVENTION

1. Field of the Invention

The present invention generally relates to a spring assembly for attachment to an accelerator pedal of a motor vehicle for improving the overall fuel economy of the vehicle. More particularly, the present invention relates to a spring assembly usable in combination with an accelerator pedal for providing non-linear resistance to compressive spring displacement via the pedal for minimizing fuel consumption.

2. Description of the Prior Art

U.S. Pat. No. 1,483,625 ('625 patent), which issued to Armstrong, discloses a Spring Attachment for Accelerator Pedals. The '625 patent describes a spring assembly usable in combination with an accelerator pedal of a motor vehicle, which assembly comprises a coil spring, an upper plate, and a base plate. The ends of the spring are fixed to the plates. The upper plate has a keyed aperture for receiving a keyed and headed reciprocal shaft to bear against the head of the shaft. The base plate has an aperture for receiving the shaft and to bear against a surface opposite to the head of the shaft. The base plate is removable from the shaft and may be rotated to adjust the tension of the spring. The aperture of the base plate is further keyed to hold the spring in adjusted position on the shaft.

U.S. Pat. No. 3,961,598 ('598 patent), which issued to Krieger, discloses a Gas Saving Tactile Device. The '598 patent describes a sensing device adapted for attachment to a vehicle engine and responsive to the vacuum created in the intake manifold for transmitting a tactile sensation to the driver to indicate when the vehicle is being driven in an uneconomical manner. The sensing device includes a sensor which is responsive to the vacuum in the intake manifold and, when the vacuum falls below a preselected minimum, causes actuation of a vibrator associated with the throttle linkage. The vibration is transmitted through the throttle linkage to the accelerator pedal, which vibration is felt by the driver. The vibration is terminated when the vacuum in the intake manifold exceeds the preselected minimum, under which condition more economical usage of fuel is achieved.

U.S. Pat. No. 4,019,475 ('475 patent), which issued to Nuss, discloses an Automobile Acceleration Control for Fuel Economy. The '475 patent describes certain resilient means yieldably opposing the opening of the throttle for an automobile engine when the latter is accelerated too rapidly for acceptable fuel economy. Pressure actuated means responsive to inlet manifold pressure withdraws the resilient means from the path of opening movement of the throttle to enable throttle opening without opposition by the resilient means when the rate of acceleration is sufficiently low to achieve the acceptable fuel economy. The throttle opposing force of the resilient means is readily detectable by the automobile driver, but may be overcome by him when rapid acceleration is desired. Also supplemental means under the control of the driver is provided for selectively withdrawing the resilient means from the path of throttle opening movement when no indication of rapid acceleration is desired.

U.S. Pat. No. 4,077,370 ('370 patent), which issued to Spangenberg, discloses an Internal Combustion Engine Fuel Economy Improvement System. The '370 patent describes an apparatus and certain methods associated therewith for assisting the driver of an automobile driven by a drive system including an internal combustion engine to improve fuel economy. The internal combustion engine drive system has an air intake manifold, a throttle valve, an accelerator pedal and a linkage coupling the accelerator pedal to the throttle valve. The effective length of the linkage between the accelerator pedal and the throttle valve is biased to an extreme value at which the throttle valve is in a closed position when the engine is deactivated. The existence and intensity of a vacuum in the air intake manifold is determined. The effective length of the mentioned linkage is maintained biased at the extreme value at vacuum intensities up to a vacuum intensity existing in the air intake manifold at an idling rate of rotation of the internal combustion engine. On the other hand, the effective length of the mentioned linkage is varied so as to actuate the throttle valve toward a closing position in response to vacuum intensities above the vacuum intensity existing at the idling rate of rotation.

U.S. Pat. No. 4,270,501 ('501 patent), which issued to Breen et al., and U.S. Pat. No. 4,574,757 ('757 patent), which issued to Schulman et al. disclose certain Behavioral Fuel Saving Method(s) for a Motor Vehicle. The '501 patent and the '757 patent essentially describe certain assemblies usable in combination with an accelerator pedal of a motor vehicle for saving fuel in the operation of the motor vehicle by providing an increased resistance to depression of a gas pedal at increased velocities in a predetermined speed range from a lower velocity up to a predetermined upper velocity. A piston is urged against the pedal by a spring in a cylinder. Adjustments in vacuum in the cylinder are utilized to adjust the spring force constituting the resistance to pedal depression of the piston.

U.S. Pat. No. 4,408,293 ('293 patent), which issued to Avins, discloses an Automotive Control System for Improving Fuel Consumption. The '293 patent describes an automobile control system which saves fuel while reducing environmental pollution. The accelerator pedal of a vehicle is monitored to provide a control signal indicative of the magnitude of the depression of the pedal. A first sensor monitors engine speed, while a second sensor monitors vehicle speed. A comparator aided by mode selected logic automatically selectively compares either the engine speed signal or the vehicle speed signal with the control signal and the throttle is automatically advanced or retarded for a given accelerator pedal position to provide operation with low fuel consumption and improved transmission shifting. In a mode which is particularly economical of fuel consumption for highway driving, the average vehicle speed is controlled by the accelerator pedal and automatically is caused to vary slightly in a cyclical manner so that intervals of acceleration are followed by intervals of coasting in which the throttle is substantially closed. The coasting intervals automatically increase when the drag is low and decrease when the drag is high. The system further simplifies changing from coasting or free wheeling to direct drive by automatically adjusting the engine shaft speed to coincide with the drive shaft speed when engine braking is required.

U.S. Pat. No. 4,475,506 ('506 patent), which issued to Riordan, discloses a Programmable Fuel Economy Optimizer for an Internal Combustion Engine. The '506 patent describes a self-adaptive fuel control system for an internal combustion engine which provides maximum fuel economy over all conditions of engine operation. Maximum fuel economy is provided by maintaining engine operation at a preselected point on the r.p.m. vs. fuel flow curve, said preselected point being near the border line of lean misfire but at a displacement from the point of misfire sufficient to provide smooth running.

U.S. Pat. No. 4,510,906 ('906 patent), which issued to Klatt, discloses an Accelerator Pedal Mechanism for Optimizing Fuel Economy. The '906 patent describes an accelerator pedal control mechanism provides a positionable stop to resist pedal depression beyond a point at which optimum fuel economy is realized during vehicle acceleration. The position of the stop relative to the accelerator pedal is controlled by an electronic circuit that is programmed to select the desired point of accelerator depression for a given condition of engine operating parameters. A caged limit spring is carried on the underside of the accelerator pedal for engagement with the stop, thus allowing the operator to sense the additional resistance of the spring through the accelerator pedal when the appropriate amount of accelerator depression is reached. The spring allows the operator to override the programmed control by pressing on the accelerator pedal with sufficient force to overcome the limit spring.

With regard to the '625 patent, it is noted that the prior art device is a design that is suggested as part of the original throttle assembly during production of an automobile to simply disengage the throttle when the operator removes their foot. The present invention is expressly designed as an add-on after production device to be added to the existing throttle assembly of modern vehicles to provide additional resistance when the throttle is engaged.

Further, the spring design of the device shown in the '625 patent is distinctive compared to the present invention. In this regard, it is noted that the prior art shows fairly tight coils in a perfectly symmetrical spring design that would provide nearly equal resistance throughout the engagement and compression. The device according to the present invention comprises widely spaced coils with a non-symmetrical design that provides lower resistance to initial compression and dramatically increased resistance the further it is engaged.

The device of the '625 patent shows a hook-up as part of the original vehicles throttle assembly, specifically, with the accelerator push-rod going directly through the top of the spring and exiting through the bottom of the spring through the floor board while connecting to the rest of the throttle assembly under the floor board. The device according to the present invention bears no relation to the existing throttle assembly and the hook-up is completely different. The current device attaches to the accelerator pedal completely independent of the existing throttle assembly of modern motor vehicles with simple screws, washers and nuts.

Further, the prior art device of the '625 patent teaches a permanent installation. The device according to the present invention is designed to be installed or removed in minutes. The prior art device of the '625 patent makes no claims of and has no fuel saving aspects or capabilities in the design. In contradistinction thereto, the device according to the present invention changes the way an operator physically interacts with the vehicle aiding in behavioral changes that increase fuel efficiency after installation.

Thus from a review of the foregoing disclosures it will be seen that the prior art perceives a need for fuel-saving kit or spring assembly outfittable upon an accelerator pedal for providing non-linear resistance as a function of compressive spring displacement via the pedal for improving fuel economy of a motor vehicle. In other words, as pedal displacement increases from the relaxed position via the additional spring assembly, resistance to pedal displacement increases non-linearly for minimizing excess pedal displacement and fuel consumption. The prior art perceives a need for such an assembly or kit, as addressed in more detail hereinafter.

### SUMMARY OF THE INVENTION

It is an object of the present invention to provide an apparatus that addresses fuel savings in a simple manner. To this end, the current invention combines existing common parts that as a whole solve a complex problem effectively and with simplicity. To reach production and deployment, the prior art would likely demand some sort of custom production of parts that do not otherwise exist. Notably, the prior art disclosures describe fuel saving devices that are complex to produce and install on a vehicle at exorbitant prices. The current invention can be assembled and installed very cost effectively. It is estimated that the prior art devices will cost more than twenty times what the current device costs to solve the same problem.

A further object of the present invention is to provide progressive resistance to over-acceleration without having to integrate feedback from any other vehicle systems. Still further, it is an object of the present invention to provide easy installation time in minutes as opposed to other systems that may take more than a full day to install. The current device is adaptable to function on any vehicle. Prior art devices would require custom parts for different vehicles. The simplicity and low cost of my device line up perfectly towards deployment on a very large scale which could significantly help alleviate the current energy crisis both short term and long term while saving users money on fuel. The prior art devices do not scale effectively which is likely why none of the designs have ever made it to mass production and deployment.

To achieve these and other readily apparent objectives, the present invention provides a spring assembly-accelerator pedal combination for enhancing fuel economy of a motor vehicle. The combination of elements essentially comprises a state of the art accelerator pedal, a conical compression spring, and fastening hardware to attach the compression spring to the pedal. An optional spring receiver or spring seat may be included for installations having a non-uniform underlying surface for maintaining the axis of the spring.

The pedal has an upper pedal surface, a lower pedal surface and a pedal aperture extending between the upper and lower pedal surfaces. The conical compression spring has an open upper spring end with a first diameter and an open lower spring end with a second diameter. The first diameter at the upper spring end is lesser in magnitude than the second diameter at the lower spring end. The fastening hardware may thus be received by way of the lower spring end for attaching the upper spring end to the pedal.

The fastening assembly functions to attach said spring to said pedal, the fastening assembly comprising a bolt, a flat washer with an outer diameter, a lock washer, and a nut, said bolt having a head and a shaft. The shaft is insertable through the pedal aperture and the open upper spring end. The bolt head is engageable with the upper pedal surface. The outer diameter of the flat washer is greater in magnitude than the diameter of the upper spring end, and lesser in magnitude than the second diameter.

The flat washer is thus receivable by the spring and the shaft via the lower spring end for sandwiching the upper spring end against the lower pedal surface. The lock washer and nut are receivable by the shaft for fastening the spring to the pedal. The spring is compressible intermediate the lower pedal surface and a fixed surface underlying the pedal such as the floor of an automobile. The spring thereby provides non-linear resistance as a function of compressive spring displacement via the pedal for improving fuel economy of a motor vehicle.

The spring base rests on the floorboard of the motor vehicle in most installations. An optional spring seat assembly is contemplated for those few installations requiring added spring stability at the lower spring end.

Other objects of the present invention, as well as particular features, elements, and advantages thereof, will be elucidated or become apparent from, the following description and the accompanying drawing figures.

### BRIEF DESCRIPTION OF THE DRAWINGS

Other features of my invention will become more evident from a consideration of the following brief description of patent drawings:

FIG. 1 is an enlarged side perspective type depiction of the spring assembly according to the present invention as attached to a fragmentary accelerator pedal.

FIG. 2 is a fragmentary side view depiction of an upper portion of a conical spring according to the present invention showing a flattened upper surface at the upper spring end.

FIG. 3 is a top view depiction of the spring assembly according to the present invention as attached to a fragmentary accelerator pedal.

FIG. 4 is a top perspective type depiction of a spring assembly kit as disassembled according to the present invention showing a conical compression spring, a bolt, a flat washer, a lock washer, and a nut.

FIG. 5 is a side view depiction of the spring assembly according to the present invention in exploded form being assembled or attached to a fragmentary accelerator pedal intermediate a fixed surface underlying the accelerator pedal.

FIG. 6 is a side view depiction of the spring assembly according to the present invention as attached to a fragmentary accelerator pedal intermediate a fixed surface underlying the accelerator pedal, the pedal being forced downward thereby compressively displacing the spring from a relaxed state and enabling non-linear resistance.

FIG. 7 is a top plan view of the compression spring depicting relative diametrical sizes for coil structure from top to bottom of the spring.

FIG. 8 is a side view depiction of a spring seat or receiver as attached to a fixed surface according to the present invention with parts thereof broken away to show the lower spring end of the conical compression spring being received within the seat the walls of which prevent sideways displacement of the lower spring end for maintaining the spring axis during spring compression.

FIG. 9 is a top plan view of the spring seat showing a peripheral seat wall and a centralized aperture for receiving hardware for fastening the seat to the underlying fixed surface.

FIG. 10 is a side perspective view of the compression spring in a relaxed state before compression showing relatively equal spacing between coil structure from top to bottom of the spring.

FIG. 11 is a side perspective view of the compression spring in a compressed state showing relatively unequal spacing between coil structure from top to bottom of the spring, thus illustrating non-linear resistance to compressive spring displacement.

FIG. 12 is a graphical depiction of resistance (X-axis) as a function of compressive spring displacement (Y-axis), which graphical depiction shows a non-linear relation between resistance and displacement.

### DETAILED DESCRIPTION OF THE PREFERRED EMBODIMENT

Referring now to the drawings with more specificity, the present invention essentially discloses a spring assembly and accelerator pedal combination or spring-assembly-accelerator pedal combination for enhancing overall fuel economy of a motor vehicle. The combination of elements thus preferably comprises an accelerator pedal 10; a compression spring 11; a fastening assembly; and a spring seat 12. The fastening assembly preferably comprises a bolt 13, a flat washer 14 with an outer diameter, a lock washer 15, and a nut 16. The bolt 13 preferably comprises a rounded head as at 17 and a threaded shaft as at 18.

The accelerator pedal 10 comprises an upper pedal surface as at 19, a lower pedal surface as at 20, and a pedal aperture 21 extending between the upper and lower pedal surfaces 19 and 20. It is contemplated that the accelerator pedal 10 is state of the art and that aperture 21 is formed therein by way of drilling a hole through the pedal 10 for receiving the shaft 18 of bolt 13. Conceivably the aperture 21 could by countersunk so that the head 17 of bolt 13 may lie under the plane of the upper pedal surface 19 so as to not otherwise interfere with pedal operation via one's foot.

The compression spring 11 is preferably conical in design as may be generally gleaned from an inspection of the figures. The spring thus preferably comprises a circular, open, upper spring end 22 with a first diameter and a circular, open, lower spring end 23 with a second diameter. The upper spring end 22 preferably comprises a flattened upper spring surface as at 25. It is contemplated that the flattened upper spring surface 25 improves attachment of the spring 11 to the pedal 10 at the lower pedal surface 10. The diameter of the upper spring end 22 is preferably lesser in magnitude than the diameter of the lower spring end 23. In other words, the first diameter is preferably lesser in magnitude than the second diameter.

The fastening assembly, comprising elements 13, 14, 15, and 16, functions to attach the spring 11 at the upper spring end 22 to the pedal 10. The shaft 18 of bolt 13 is inserted through the pedal aperture 21 and the open upper spring end 22. The round head 17 is engaged with the upper pedal surface 19 (or a countersunk portion of the pedal 10) and preferably comprises a flat head screw slot.

The rounded upper surface of the head 17 essentially functions to enhance forceful contact with the upper pedal surface 19 by diverting forceful contacts away from the head 17 other than downwardly directed forceful contacts. In other words, a head having sharp edges may snag a user's foot during pedal operation thereby causing unwanted interference with the pedal 10. The rounded head 17 helps alleviate the tendency for matter to snag the head 17 and cause unwanted forces thereupon.

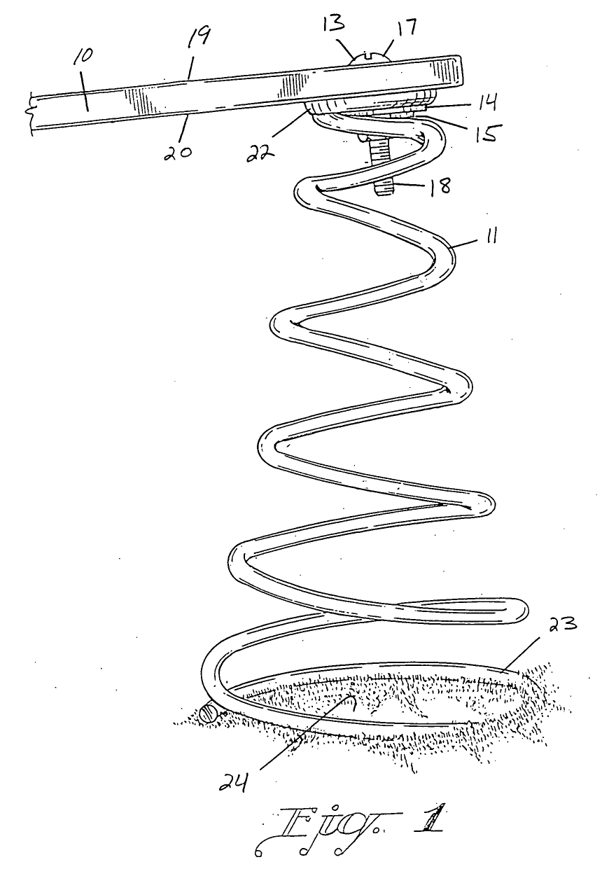

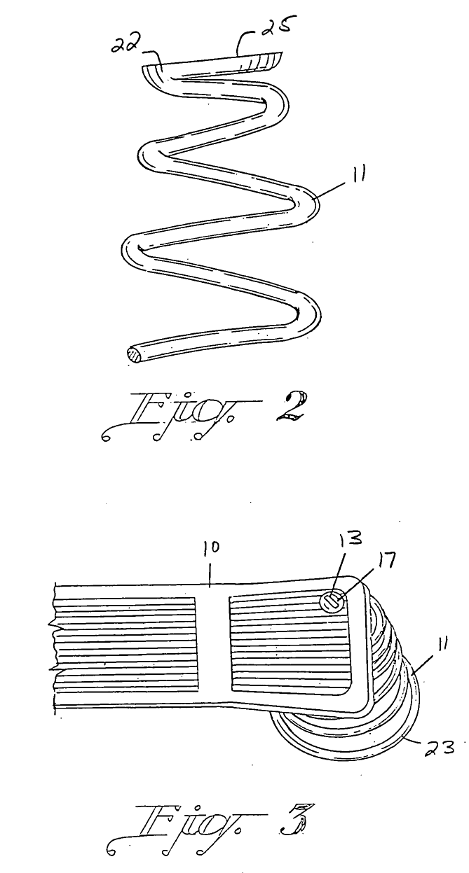

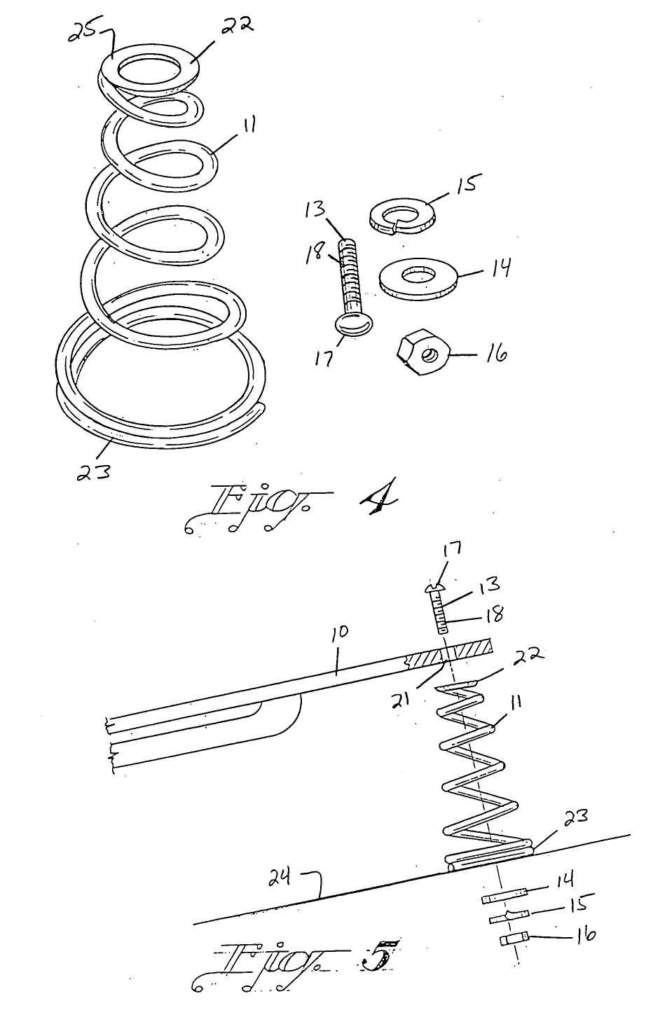

The outer diameter of the flat washer 14 is preferably greater in diameter than the first diameter or diameter of the upper spring end 22 and the inner diameter of the washer 14 is greater in magnitude than the diameter of the shaft 17. Notably, however, the outer diameter of washer 14 is lesser in magnitude than the second diameter or diameter of the lower spring end 23, and is thus receivable by the spring 11 and the shaft 17 via the lower spring end 23 for sandwiching the upper spring end 22 against the lower pedal surface 20 as generally and comparatively depicted in FIGS. 1, 5, and 6.

The lock washer 15 and nut 16 are further received by said shaft 17 for fastening the spring 11 to the pedal 10. When a force (as at 101) is applied to the pedal 10, the spring 11 is compressible (as at 100) intermediate the lower pedal surface 20 and an underlying fixed surface 24 such as the underlying floor of an automobile.

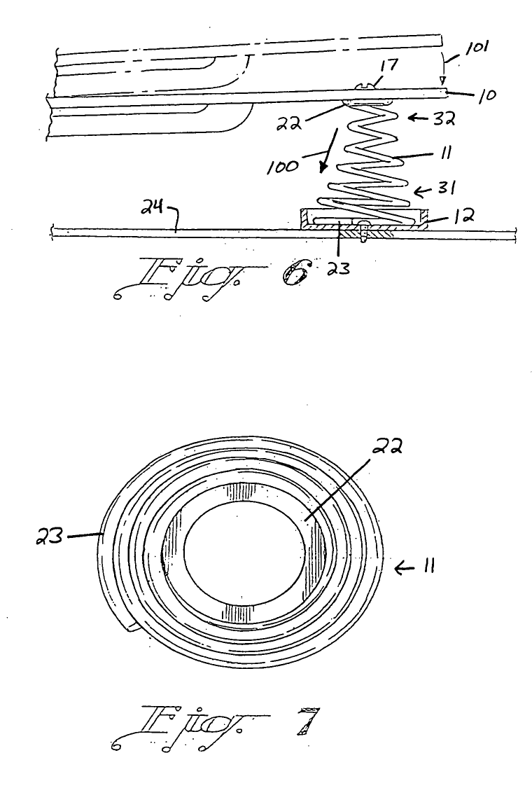

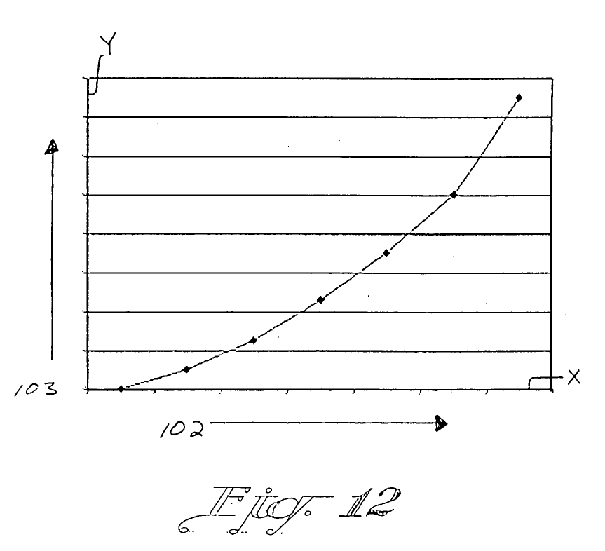

It may be seen from an inspection of FIG. 6 and a comparative inspection of FIGS. 10 and 11 that when the conical compression spring 11 is compressively displaced from a relaxed state (as depicted in FIG. 10) to a compressed stated (as depicted in FIGS. 6 and 11) via force 101, the spacing intermediate lower coil portions 31 of the spring 11 displace at a faster rate than upper coil portions 32 of the spring 11. In other words, when spring 11 is compressed, lower coil portions 31 will compressively displace before upper coil portions 32.

The conical compression spring 11 thereby provides non-linear resistance (via spring restorative forces) (resistance 102 being graphed along the X-axis in FIG. 12) as a function of compressive spring displacement (from a relaxed spring state) (spring displacement 103 being graphed along the Y-axis in FIG. 12) via the pedal 10 for improving fuel economy of the motor vehicle to which the assembly is attached.

The compression resistance rate for this fuel-saving device becomes non-linear once the larger diameter adjacent coils come in contact with one another during compression. This loss of active coils will cause it to be come stiffer, providing progressive resistance to accelerator engagement.

The full uncompressed length of the spring 11 is preferably and approximately 4 inches. The top outer dimension of the spring is preferably 0.843 inches and the bottom outer dimension of the spring is preferably 2.218 inches. The spring steel wire of the spring 11 is preferably 0.110 inches in transverse diameter with a zinc finish. The average compression resistance rate is 14.7 lbs/in.

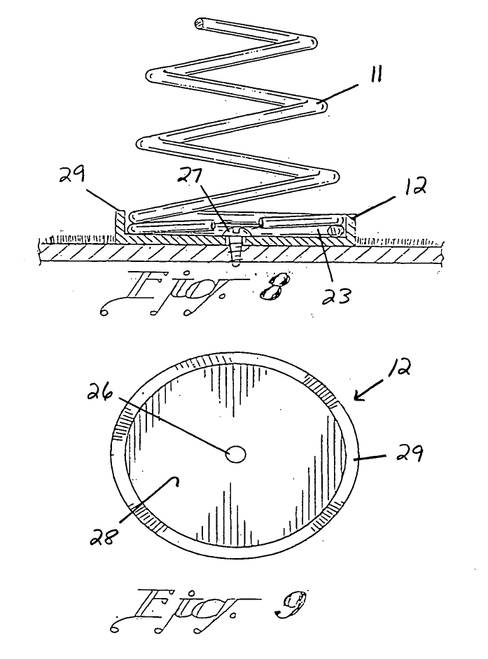

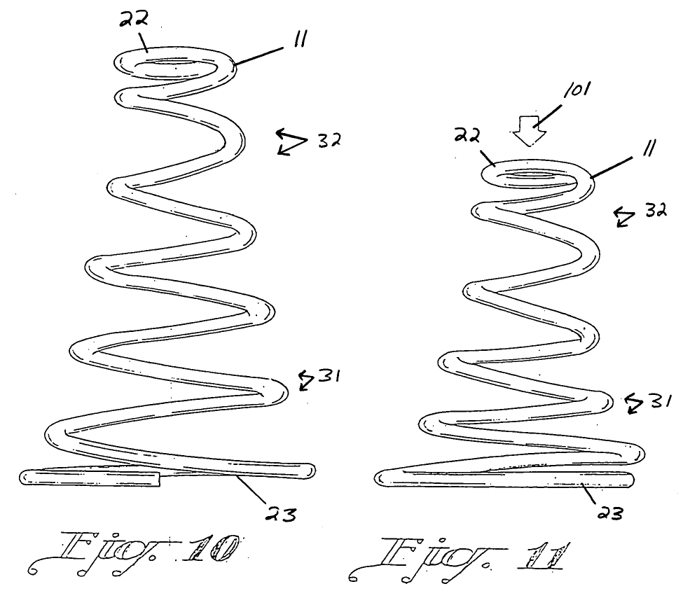

The optional spring seat or floor mount receiver 12 is generally depicted in FIGS. 7 and 8. It is contemplated that the receiver or seat 12 may preferably be formed from plastic to hold the lower spring end 23 in place or to maintain the axis of the spring 11 during compression. Typically, the receiver or seat 12 would be utilized for installations where contact between the lower spring end 23 and the fixed surface 24 is non-uniform or likely to cause spring axis displacement during compression.

The spring seat 12 is preferably attachable to the underlying fixed surface 24 by way of certain fastening means as may be defined by a self-tapping screw 27 and an aperture 26 formed in the bottom 28 of the seat 12. The seat comprises an upwardly extending circular seat wall 29, which wall 29 has a wall diameter being sized for receiving the lower spring end 23. The wall 29 thus prevents sideways displacement of the lower spring end 23 and thus functions to maintain a fixed spring axis during spring compression.

Due to the variable distance between the bottom of the accelerator pedal 10 and the floor board or surface 24 in vehicles of different makes and models, the uncompressed length of the fuel saving device or assembly will vary to appropriately fit each installation. The range of usable springs for this application is wide, with uncompressed lengths from 2 inches to 6 inches. The average resistance rate of compression will vary from 5 lbs/in to 25 lbs/in to meet the desired resistance level of the vehicle operator. The wire diameter will vary in relation to the installed compression resistance.

The number of coils will vary depending on the length of the installed spring. Springs with less space between coils will not be ideal or this application because they will not allow for full depression of the accelerator if necessary, and will complicate the installation procedure. Springs with top outer dimensions of less than 0.25 inches are not ideal for this application as the connection procedure would be more difficult. Springs with bottom outer dimensions of less than 1 inch are not ideal for this application as the base of the spring that rests on the floor board would be highly unstable providing inconsistent resistance to accelerator engagement.

While the foregoing specifications and drawings are set forth in some detail, the specific embodiments described and illustrated thereby are to be considered as exemplifications of the principles of the underlying invention and are not intended to limit the same to the specific embodiments illustrated. For example, it is contemplated that the invention may be said to essentially comprise a spring assembly or fuel-saving kit outfittable upon an accelerator pedal of a motor vehicle for enhancing the overall fuel economy of a motor vehicle.

The spring assembly or fuel-saving kit may be said to essentially comprise a compression spring and a fastening assembly. The spring has an open upper spring end with a first diameter and an open lower spring end with a second diameter, the first diameter being lesser in magnitude than the second diameter. The fastening assembly functions to attach the spring to an accelerator pedal, and thus essentially comprises a bolt and a nut.

The bolt has a head and a shaft, which shaft being insertable through a pedal aperture pre-formed in the pedal. The bolt is further insertable through the open upper spring end, and the head is engageable with an upper pedal surface of the pedal. The nut is receivable by the shaft for fastening the spring to the pedal. The spring is compressible intermediate the lower pedal surface and an underlying fixed surface such as the floor of an automobile, and thereby provides resistance as a function of compressive spring displacement via downward pedal movement for improving fuel economy of a motor vehicle.

The spring assembly or fuel-saving kit may further preferably comprise a flat washer with an outer or third diameter, which diameter is greater in diameter than the first or upper spring end diameter, but lesser in magnitude than the second or lower spring end diameter. The flat washer is thus receivable by the spring and shaft via the lower spring end and thereby fastenable via the nut for sandwiching the upper spring end against the lower pedal surface. The spring assembly kit may further preferably comprise a lock washer, which lock washer is receivable by the shaft of the bolt intermediate the flat washer and the nut for enhancing fastened attachment of the spring to the pedal.

The spring assembly or fuel-saving kit according to the present invention may further comprise a spring seat or receiver structure, which seat is attachable to a fixed surface underlying the pedal. The seat preferably comprises an upwardly extending circular seat wall having a wall diameter sized for receiving the lower spring end. The lower spring end, when received in the seat prevents sideways displacement of the lower spring end and thus essentially functions to maintain a fixed spring axis during spring compression.

Further, it is contemplated that the spring assembly provides support for certain fuel-saving methodology. In this regard, it is contemplated that the present invention may be said to provide a fuel-saving method comprising a series of steps, including: installing compressive spring means (as definable by spring 11) for resisting force intermediate an accelerator pedal (as at 10) and a fixed surface underlying said pedal (as at 23); displacing said pedal downwardly; resisting the downward pedal displacement via the compressive spring means; and minimizing fuel consumption by forcing said pedal upwardly via said compressive spring means. Notably, the step of resisting the downward pedal displacement may preferably be defined by non-linear resistance as a function of pedal displacement as set forth in the foregoing specifications.

From the specifications, it will be observed that numerous variations and modifications may be effected without departing from the spirit and scope of the invention. It is to be understood that no limitation with respect to the specific supporting embodiments illustrated herein is intended or should be inferred. It is, of course, intended to cover by the appended claims all such modifications as fall within the scope of the claims.

I claim:

1. A spring assembly-accelerator pedal combination, said combination for enhancing fuel economy of a motor vehicle, said combination comprising:
an accelerator pedal, said pedal having an upper pedal surface, a lower pedal surface and a pedal aperture extending between the upper and lower pedal surfaces;
a compression spring, said spring having an open upper spring end with a first diameter and an open lower spring end with a second diameter, the first diameter being lesser in magnitude than the second diameter; and
a fastening assembly for attaching said spring to said pedal, the fastening assembly comprising a bolt, a flat washer with an outer diameter, a lock washer, and a nut, said bolt having a head and a shaft,
the shaft being insertable through the pedal aperture and the open upper spring end, the round head being engageable with the upper pedal surface, the outer diameter being greater in magnitude than the first diameter and lesser in magnitude than the second diameter, said flat washer thus being receivable by said spring and said shaft via the lower spring end for sandwiching the upper spring end against the lower pedal surface, the lock washer and nut being receivable by said shaft for fastening said spring to said pedal, the spring being compressible intermediate the lower pedal surface and an underlying fixed surface, the spring thereby providing resistance as a function of compressive spring displacement via the pedal for improving fuel economy of a motor vehicle.

2. The combination of claim 1 wherein the upper spring end comprises a flattened upper spring surface, the flattened upper spring surface for improving attachment of the spring to the pedal at the lower pedal surface.

3. The combination of claim 2 wherein the head comprises a rounded upper surface, the rounded upper surface for enhancing forceful contact with the upper pedal surface.

4. The combination of claim 3 wherein the spring provides non-linear resistance as a function of compressive spring displacement via the pedal for improving fuel economy of a motor vehicle.

5. The combination of claim 4 wherein the compression spring is conical, the conical compression spring for providing non-linear resistance as a function of compressive spring displacement.

6. The combination of claim 5 comprising a spring seat, the spring seat being attachable to the underlying fixed surface and having an upwardly extending circular seat wall, the circular seat wall having a wall diameter, the wall diameter being sized for receiving the lower spring end, the spring seat for maintaining a fixed spring axis during spring compression.

7. A spring assembly for enhancing fuel economy of a motor vehicle, the spring assembly comprising:
a compression spring, said spring having an open upper spring end with a first diameter and an open lower spring end with a second diameter, the first diameter being lesser in magnitude than the second diameter; and
a fastening assembly for attaching said spring to an accelerator pedal, the fastening assembly comprising a bolt and a nut, said bolt having a head and a shaft, the shaft being insertable through a pedal aperture formed in said pedal and the open upper spring end, the head being engageable with an upper pedal surface of said pedal, the nut being receivable by said shaft for fastening said spring to said pedal, the spring being compressible intermediate the lower pedal surface and an underlying fixed surface, the spring thereby providing resistance as a function of compressive spring displacement via the pedal for improving fuel economy of a motor vehicle.

8. The spring assembly of claim 7 wherein the upper spring end comprises a flattened upper spring surface, the flattened upper spring surface for improving attachment of the spring to the pedal at a lower pedal surface.

9. The spring assembly of claim 7 wherein the head comprises a rounded upper surface, the rounded upper surface for enhancing forceful contact with the upper pedal surface.

10. The spring assembly of claim 7 wherein the spring provides non-linear resistance as a function of compressive spring displacement via said pedal for improving fuel economy of a motor vehicle.

11. The spring assembly of claim 10 wherein the compression spring is conical, the conical compression spring for providing non-linear resistance as a function of compressive spring displacement.

12. The spring assembly of claim 7 comprising a flat washer with a third diameter, the outer diameter being greater in diameter than the first diameter and lesser in magnitude than the second diameter, said flat washer thus being receivable by said shaft and said spring via the lower spring end and thereby fastenable via the nut for sandwiching the upper spring end against a lower pedal surface.

13. The spring assembly of claim 12 comprising a lock washer, the lock washer being receivable by said shaft intermediate the flat washer and the nut for enhancing fastened attachment of said spring to said pedal.

14. The spring assembly of claim 7 comprising a spring seat, the spring seat being attachable to the underlying fixed surface and having an upwardly extending circular seat wall, the circular seat wall having a wall diameter, the wall diameter being sized for receiving the lower spring end, the spring seat for maintaining a fixed spring axis during spring compression.

15. A fuel saving kit, said kit being outfittable upon an accelerator pedal for enhancing fuel economy of a motor vehicle, said kit comprising:
a compression spring, said spring having an upper spring end and an lower spring end; and
fastening means for attaching said spring to an accelerator pedal, the attached spring for providing resistance as a function of compressive spring displacement via said pedal for improving fuel economy of a motor vehicle.

16. The kit of claim 15 wherein the upper spring end comprises a flattened upper spring surface, the flattened upper spring surface for improving attachment of the spring to the pedal at a lower pedal surface.

17. The kit of claim 15 wherein the spring provides non-linear resistance as a function of compressive spring displacement via said pedal for improving fuel economy of a motor vehicle.

18. The kit of claim 17 wherein the compression spring is conical, the conical compression spring for providing non-linear resistance as a function of compressive spring displacement.

19. The kit of claim 15 comprising a spring seat, the spring seat being attachable to a fixed surface underlying said pedal and having an upwardly extending seat wall, the seat wall being sized and shaped for receiving the lower spring end, the spring seat for receiving the lower spring end and for maintaining a fixed spring axis during spring compression.

20. The kit of claim 15 wherein the fastening means comprise a bolt and a nut, said bolt having a head and a shaft, the shaft being insertable through a pedal aperture formed in said pedal and the upper spring end, the head being engageable with an upper pedal surface of said pedal, the nut being receivable by said shaft for fastening said spring to said pedal.

21. A fuel-saving method, the method comprising a series of steps, including:
installing compressive spring means for resisting force intermediate an accelerator pedal and a fixed surface underlying said pedal;
displacing said pedal downwardly; and
resisting the downward pedal displacement via the compressive spring means thereby minimizing fuel consumption.

22. The fuel-saving method of claim 21 wherein the step of resisting the downward pedal displacement is defined by non-linear resistance as a function of pedal displacement.
